(19) United States
(12) Patent Application Publication
(10) Pub. No.: US 2009/0235201 A1
(43) Pub. Date: Sep. 17, 2009

(54) METHODS FOR CONTROLLING DISPLAY OF ON-SCREEN MENUS

(76) Inventors: Aaron Baalbergen, Miami, FL (US); Demian Martin, San Leandro, CA (US)

Correspondence Address: IPSG, P.C., P.O. BOX 700640, SAN JOSE, CA, 95170, US

(21) Appl. No.: 12/046,400

(22) Filed: Mar. 11, 2008

(51) Int. Cl. G06F 3/048

(52) U.S. Cl. 715/785; 715/831

(57) ABSTRACT

A method for controlling displaying information contained in a menu on a display device is disclosed. Items in the menu may be selected using a control device. Initially a first portion of the menu may be shown in a display area on the display device. The method may include monitoring a position of an indicator. The indicator may be controlled by the control device. The method may also include concealing at least a first section of the first portion of the menu if a portion of the indicator is in a first zone on the display device and if no button of the control device is currently pressed. The method may also include showing a second portion of the menu if the portion of the indicator is in the first zone on the display device and if no button of the control device is currently pressed.

### BACKGROUND OF THE INVENTION

The present invention may relate to controlling playback of media/content, such as video, audio, image, and/or text content. The invention may also relate to controlling the ambience, such as the volume, the lighting, etc., associated with the content playback. The invention may also relate to controlling scrolling on-screen menus, thereby controlling the display of the information contained in the menus.

Conventionally, controlling content playback and ambience may involve utilizing a control device that includes many discrete, dedicated buttons for controlling various playback and ambience parameters, as illustrated in the example of FIG. 1.

FIG. 1 shows a schematic representation illustrating an example prior art control device 100. Control device 100 may include multiple dedicated buttons for controlling content playback. For example, control device 100 may include a fast-forward button 102, a fast-backward (or reverse) button 104, a skip-forward button 106, and a skip-backward button 108, in addition to the play, pause, stop, and record buttons. Control device 100 may also include multiple dedicated buttons for controlling ambience. For example, control device 100 may include a volume adjustment button 112 and a lighting adjustment button 114. The large amount of the dedicated buttons may lead to several disadvantages of control device 100.

As an example, the large amount of the dedicated buttons may make control device 100 inconvenient to use and may degrade user experience in consuming content/media. For instance, if a user of control device 100 would like to turn up the volume when watching a movie on a television, given that there are many buttons on control device 100, the user may have to turn his/her attention from the television to control device 100, find volume adjustment button 112 on control device 100, and then correctly press on the right-hand part of volume adjustment button 112 to increase the volume. Much inconvenience may be involved, and the user may miss a substantial portion of the movie.

The large amount of the dedicated buttons may also cause the form factor of control device 100 to be undesirably large. For usability and/or ergonomic considerations, the buttons may need to have sufficiently large sizes and separations. Accordingly, miniaturization of control device 100 may be obstructed by the sizes and the separations of the buttons. As a result, control device 100 may not be satisfactorily portable for users, and control device 100 may incur substantially high storage and shipping costs for the manufacturer of control device 100.

Conventional control methods (e.g., for controlling playback devices, ambience devices, etc.) may also involve utilizing a control device to navigate an on-screen menu shown on a display device and to select items from the menu. For a menu that is too large (e.g., contains too many items) to be fit into a display area and displayed all at once, conventional methods may include providing direction buttons and/or a scrollbar on the display device for the user to scroll the display area, e.g., up and down, to show different portions of the menu. To actuate a direction button or drag the scrollbar for scrolling the display area, the user may need to turn his/her attention from the menu items to look for the direction button or the scrollbar. Further, the user may need to continuously press a button of the control device for actuating the direction button or dragging the scrollbar. Accordingly, the conventional methods may involve substantial inconvenience and even fatigue.

### SUMMARY OF INVENTION

An embodiment of the present invention relates to a method for controlling displaying information contained in a menu on a display device. Items in the menu may be selected using a control device. Initially a first portion of the menu may be shown in a display area on the display device. The method may include monitoring a position of an indicator. The indicator may be controlled by the control device. The method may also include concealing at least a first section of the first portion of the menu if a portion of the indicator is in a first zone on the display device and if no button of the control device is currently pressed. The method may also include showing a second portion of the menu if the portion of the indicator is in the first zone on the display device and if no button of the control device is currently pressed.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a schematic representation illustrating an example prior art control device.

FIG. 2 shows a schematic representation illustrating a control device in accordance with one or more embodiments of the present invention.

FIG. 3 shows a schematic representation illustrating a control device in accordance with one or more embodiments of the present invention.

FIG. 4 shows a schematic representation illustrating a control device in accordance with one or more embodiments of the present invention.

FIG. 5 shows a flowchart illustrating a method for controlling content playback and/or ambience in accordance with one or more embodiments of the present invention.

FIG. 6 shows a flowchart illustrating a method for controlling content playback and/or ambience in accordance with one or more embodiments of the present invention.

FIG. 7 shows a flowchart illustrating a method for controlling content playback and/or ambience in accordance with one or more embodiments of the present invention.

FIG. 8A shows a schematic representation illustrating a displayed portion of a menu and illustrating scroll zones for controlling the display of the information contained in the menu in accordance with one or more embodiments of the present invention.

FIG. 8B shows a schematic representation illustrating another portion of the menu after a display area has been scrolled with respect to the menu in accordance with one or more embodiments of the present invention.

FIG. 9 shows a flowchart illustrating a method for controlling the display of the information contained in the menu in accordance with one or more embodiments of the present invention.

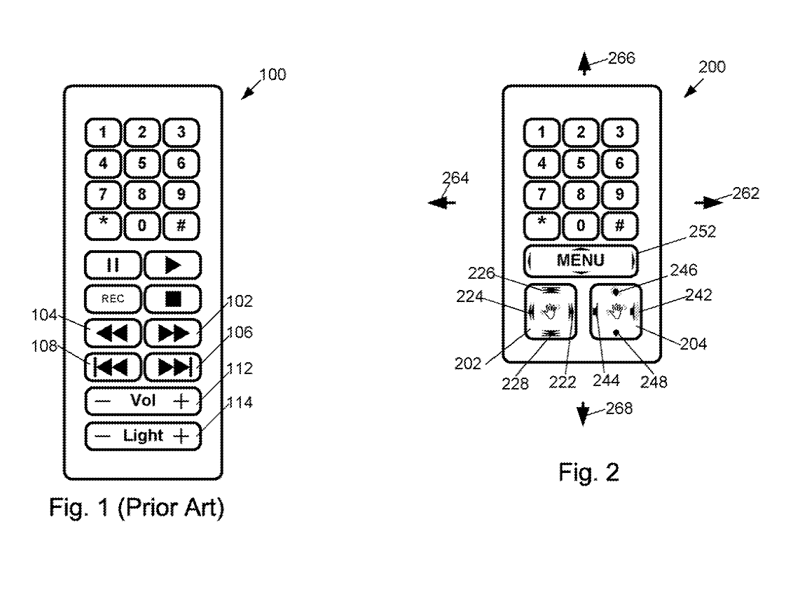

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover articles of manufacture that includes a computer readable medium on which computer-readable instructions for earning out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

One or more embodiments of the present invention relate to a method for controlling content playback and ambience. The method may enable reducing the number of buttons in control devices, thereby improving the ease-of-use and reducing the form factors of the control devices.

The method may include providing a media-control button and an ambience-control button for a control device. The method may also include receiving user input from one of the media-control button and the ambience-control button, which may be referred to as the actuated button. The method may also include receiving one or more signals pertaining to the movement, of the actuated button and/or the motion of the control device. The method may also include identifying which one of the media-control button and the ambience-control button is actuated and, accordingly, translating the one or more signals into a desirable media-control or ambience-control command. For example, the media-control or ambience-control command may represent one of the last-forward (or accelerate-forward), fast-backward (or accelerate-backward or reverse), skip-forward, skip-backward, increase-volume, decrease-volume, increase-lighting, and decrease-lighting commands associated with buttons 102, 104, 106, 108, 112, and 114 of the example prior art control device 100.

As can be readily appreciated from the above discussion, the method may reduce the number of media/ambience-control buttons from 6 (e.g., buttons 102-114) to 2 (e.g., the media-control button and the ambience-control button). Accordingly, the method may effectively improve the convenience for users in operating control devices and may enable reducing the sizes of control devices.

One or more embodiments of the present invention may relate to a control device. The control device may include a media-control button and an ambience-control button. The control device may also include one or more sensing mechanisms, such as one or more joystick sensors, capacitive sensors, pressure sensors, gyroscopes, and/or accelerometers, for generating one or more signals pertaining to the movement of the media-control button, the movement of the ambience-control button, and/or the motion of the control device in response to user operation. The control device may also include a processing/logic unit for determining which one of the media-control button and the ambience-control has been actuated aid, accordingly, translating the one or more signals into a suitable media-control or ambience control command.

One or more embodiments of the invention may relate to a method for controlling scrolling a menu, on a display device, thereby controlling the display of the information contained in the menu. The method may enable the user to simply move an on-screen indicator for actuating the scrolling. The method does not require the user to accurately and continuously click on a direction button; the method does not require the user to find a scrollbar and drag the scrollbar. Accordingly, the method may provide substantial convenience and may reduce fatigue for the user.

The method may include monitoring the position of the indicator. The method may also include scrolling the display area, which shows a portion of the menu, with respect to the menu in a first direction if a portion of the indicator is in a first scroll zone on the display device.

In one or more embodiments, the indicator may represent a pointer, and the portion of the indicator may be a pre-selected portion, such as the tip/head of the pointer. In one or more embodiments, the indicator may represent a menu-item highlighting effect, and the portion may represent an arbitrary portion of the highlighting effect.

The first scroll zone may be located near a first edge of the display area. The first scroll zone, as well as the boundary between the first scroll zone and the displayed portion of the menu, may not be visibly shown or indicated on the display device. Therefore, the user may not need to look for the first scroll zone. The first direction may be consistent with the direction in which the user moves the indicator from the displayed portion of the menu towards the first edge. Accordingly, the user may easily and intuitive move the portion of the indicator into the first scroll zone to scroll the display area with respect to the menu in the first direction. The user may not need to press or hold any button of the control device.

Scrolling the display area with respect to the menu may be considered equivalent to scrolling the menu with respect to the display area in an opposite direction. The result may include concealing at least a section of the initially displayed portion of the menu and showing a newly displayed portion of the menu.

The method may also include scrolling the display area with respect to the menu in other directions if the portion of the indicator is disposed in other scroll zones.

Alternative or in addition to monitoring the position of the indicator, one or more embodiments of the invention may include monitoring the movement of the indicator and scrolling the display area with respect to the menu in the direction of the movement of the indicator. In one or more embodiments, the acceleration, speed, and/or amount of the scrolling may be adjusted according to the movement and/or the position of the indicator. Controlling the movement and/or the position of the indicator is intuitive and simple. Accordingly, the operation for scrolling the display area also is intuitive and simple: no button or scrollbar may need to be looked for, and no button needs to be pressed or hold.

The features and advantages of the invention may be better understood with reference to the figures and discussions that follow.

FIG. 2 shows a schematic representation illustrating a control device 200 in accordance with one or more embodiments of the present invention. Control device 200 may include a “menu” button 252 for activating one or more on-screen menus, for example, to be displayed on a television screen. “Menu” button 252 may also enable a user of control device 200 to navigate the one or more menus for choosing options or providing commands. For example, “menu” button 252 may represent a multi-way button (or joystick), for example, implemented utilizing one or more joystick sensors, capacitive sensors, and/or pressure sensors, for controlling the movement of an on-screen pointer or the indication/highlighting of menu items. Alternatively or additionally, control device 200 may include one or more motion-sensing mechanisms, such as one or more accelerometers and/or gyroscopes, for facilitating the user of control device 200 to navigate menus and/or to select menu items through various gestures that cause various motions of control device 200.

Control device 200 may also include a media-control button 202 and an ambience-control button 204. Media-control button 202 may represent a multi-way button (or joystick) including at least four media-control portions, e.g., a portion 222, a portion 224, a portion 226, and a portion 228, for receiving user input to generate signals associated with at least four media-control commands, e.g., a fast-forward (or accelerate-forward) command, a fast-backward (or accelerate-backward) command, a skip-forward command, and a skip-backward command, respectively. Alternatively or additionally, one or more of the media-control portions may be associated with one or more other media-control commands. Ambience-control button 204 may represent a multi-way button (or joystick) including at least four ambience-control portions, e.g., a portion 242, a portion 244, a portion 246, and a portion 248, for receiving user input to generate signals associated with at least four ambience-control commands, e.g., an increase-volume command, a decrease-volume command, an increase-lighting command, and a decrease-lighting command, respectively. Alternatively or additionally, one or more of the ambience-control portions may be associated with one or more other ambience-control commands, such as an increase-temperature command, a decrease-temperature command, a open-blinds command, and/or a close-blinds command.

Control device 200 may include additional sensing mechanisms, such as one or more joystick sensors, capacitive sensors, and/or pressure sensors, coupled with media-control button 202 and/or ambience-control button 204 for generating more sophisticated control signals. For example, the amount of the capacitance and/or the pressure resulted from the user input received at portion 222 of media-control button 202 may be translated into a fast-forward speed at which the consumed content is to be fast-forwarded; the amount of the capacitance and/or the pressure resulted from the user input received at portion 242 of ambience-control button 204 may be translated into a volume-increase speed/rate at which the volume for playing back content is to be increased.

Additionally or alternatively, the one or more motion-sensing mechanisms of control device 200 may enable the user to provide sophisticated media-control and ambience-control commands utilizing various gestures that cause various motions of control device 200. For example, the signals related to the motions of control device 200 in directions 262 (to the right), 264 (to the left), 266 (forward), and 268 (backward) may be translated into the fast-forward command, the fast-backward command, the skip-forward command, and the skip-backward command, respectively, if media-control button 202 is actuated (e.g., pressed or touched) or into the increase-volume command, the decrease-volume command, the increase-lighting command, and the decrease lighting command, respectively, if ambience-control button 204 is actuated. The acceleration of the motion of control device 200 in each of the directions may be translated into the acceleration, the speed (or change rate), and/or the amount of the associated action.

Control device 200 may also include a processing/logic unit for determining which one of media-control button 202 and ambience-control 204 has been actuated and, accordingly, translating signals into suitable media-control and/or ambience control commands.

In comparison with the example prior art control device 100, which requires six buttons for media control and ambience control, control device 200 needs only two buttons for media control and ambience control. Accordingly, the form factor of control device 200 may be substantially smaller than the form factor of control device 100. Advantageously, control device 200 may provide superior portability; control device 200 may require lower storage and shipping costs.

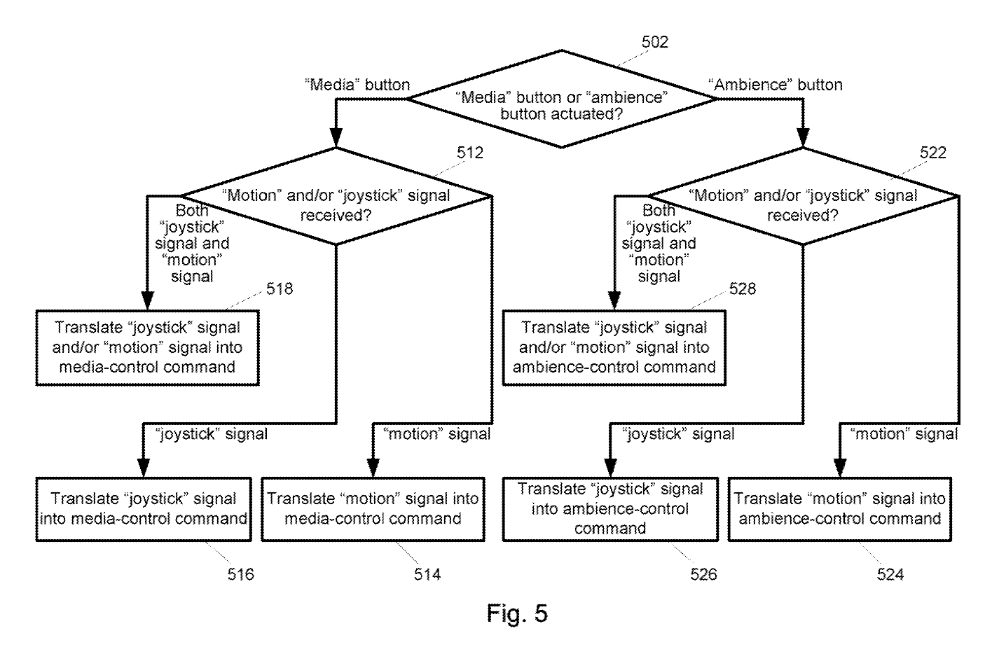

Example operation methods, features, and advantages of control device 200 are further discussed below with reference to the example of FIG. 5.

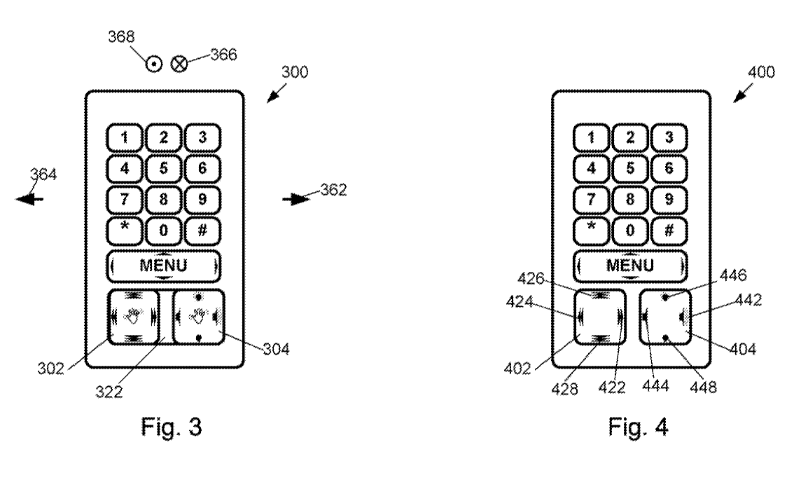

FIG. 3 shows a schematic representation illustrating a control device 300 in accordance with one or more embodiments of the present invention. Control device 300 may include a media-control button 302 and an ambience-control button 304. Each of media-control button 302 and ambience-control button 304 may represent a simple on/off button for a user of control device 300 to activate/deactivate media control or ambience control, in one or more embodiments, media-control button 302 and ambience-control button 304 may represent two portions of a multi-way (e.g., two-way or three-way) button 322.

Control device 300 may also include one or more motion-sensing mechanisms, such as one or more accelerometers and/or gyroscopes, for enabling a user of control device 300 to provide sophisticated media-control aid ambience-control commands through various gestures that cause various motions of control device 300. For example, the signals related to the motions of control device 300 in directions 362 (to the right), 364 (to the left), 366 (downward), and 368 (upward) may he translated into a fast-forward command, a fast-backward command, a skip-forward command, and a skip-backward command, respectively, if media-control button 302 is actuated (e.g., pressed or touched) or into an increase-volume command, a decrease-volume command, an increase-lighting command, and a decrease lighting command, respectively, if ambience-control button 304 is actuated. The acceleration of the motion of control device 300 in each of the directions may be translated into the acceleration, the speed (or change rate), and/or the amount of the associated action.

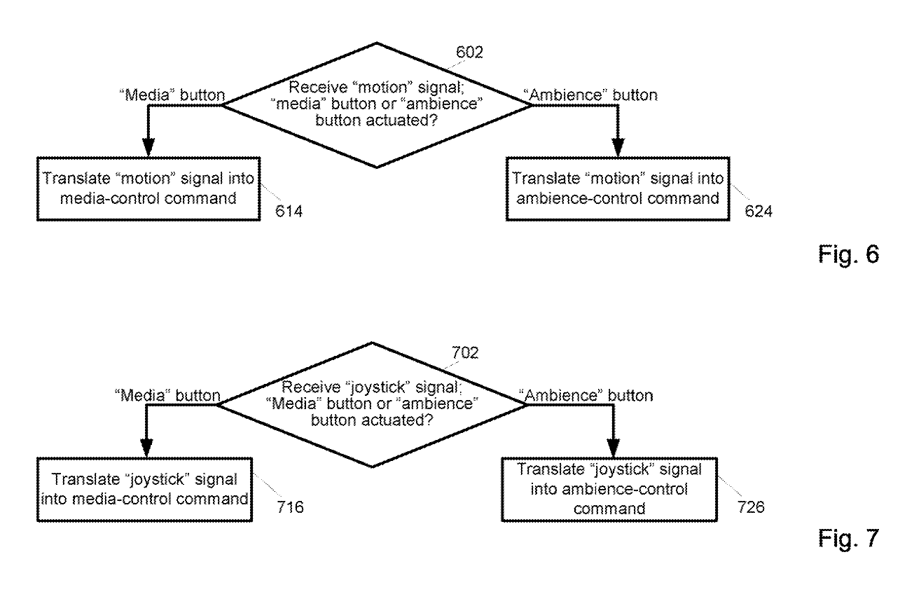

Control device 300 may also have substantial convenience and form-factor advantages over the example prior art control device 100. Example operation methods, features, and advantages of control device 300 are further discussed below with reference to the example of FIG. 6.

FIG. 4 shows a schematic representation illustrating a control device 400 in accordance with one or more embodiments of the present invention. Control device 400 may include a media-control button 402 and an ambience-control button 404. Media-control button 402 may represent a multi-way button (or joystick) including at least four portions, e.g., a portion 422, a portion 424, a portion 426, and a portion 428, for receiving user input to generate signals associated with at least four media-control commands, e.g., a fast-forward (or accelerate-forward) command, a fast-backward (or accelerate-backward) command, a skip-forward command, and a skip-backward command, respectively. Ambience-control button 404 may represent a multi-way button, (or joystick) including at least four portions, e.g., a portion 442, a portion 444, a portion 446, and a portion 448, for receiving user input to generate signals associated with at least four ambience-control commands, e.g., an increase-volume command, a decrease-volume command, an increase-lighting command, and a decrease-lighting command, respectively.

Control device 400 may include additional sensing mechanisms, such as one or more joystick sensors, capacitive sensors, and/or pressure sensors, coupled with media-control button 402 and/or ambience-control button 404 for generating more sophisticated control signals. For example, the amount of the capacitance and/or the pressure resulted from the user input received at portion 428 of media-control button 402 may be translated into a skip-backward speed at which certain content is to be skipped backwards according to a set of section/chapter marks associated with the content; the amount of the capacitance and/or the pressure resulted from the user input received at portion 448 of ambience-control button 404 may be translated into a lighting-decrease speed/rate at which the lighting in the room for playing back certain content is to be decreased.

Control device 400 may also have substantial convenience and form-factor advantages over the example prior art control device 100. Example operation methods, features, and advantages of control device 400 are further discussed below with reference to the example of FIG. 7.

FIG. 5 shows a flowchart illustrating a method for controlling content playback and/or ambience in accordance with one or more embodiments of the present invention. The method may be implemented, for example, utilizing control device 200 illustrated in the example of FIG. 2. The method may start with step 502, in which control device 200 (or the processing/logic unit therein) may determine which one of media-control button 202 and ambience-control button 204 is actuated (e.g., pressed or touched). Control device 200 may identify the actuated button when or after one or more signals are provided by one or more sensing mechanisms in control device 200. If media-control button 202 is actuated, control may be transferred to step 512; if ambience-control button 204 is actuated, control may be transferred to step 522.

In step 512, control device 200 (and/or the media playback device controlled by control device 200) may determine whether one or more signals pertaining to the motion of control device 200 (referred to as one or more “motion” signals) or one or more signals pertaining to the movement of media-control button 202 (referred to as one or more “joystick” signals) have been received. If one or more “motion” signals (but no “joystick” signals) have been received, control may be transferred to step 514; if one or more “joystick” signals (but not “motion” signals) have been received, control may be transferred to step 516; if one or more “motion” signals and one or more “joystick” signals have been received, control may be transferred to step 518.

In step 514, control device 200 (and/or the controlled media playback device) may translate the one or more “motion” signals into a media-control command. The one or more “motion” signals may include one or more direction signals and/or one or more magnitude signals. The one or more direction signals may be translated into one of the accelerate-forward (or fast-forward), accelerate-backward (or fast-backward), skip-forward, and skip-backward function commands. The one or more magnitude signals may be translated into a magnitude (e.g., acceleration, speed, and/or amount) command associated with the function command determined based on the one or more direction signals. The media-control command may include the function command and/or the magnitude command. As an example, if the one or more “motion” signals include a direction/orientation signal associated with direction 264, the one or more “motion” signals may be translated into the accelerate-backward (or fast-backward) command for reversing the content played by the media playback device. The one or more “motion” signals may also include at least a magnitude signal (e.g., provided by the one or more motion-sensing mechanisms) related to the acceleration, the speed, and/or the distance of movement of control device 200 in direction 262. According to the magnitude signal control device 200 (and/or the controlled media playback device) may adjust the acceleration, the speed, and/or the amount for reversing the content playback.

In step 516, control device 200 (and/or the controlled media playback device) may translate the one or more “joystick” signals into a media-control command. The one or more “joystick” signals may also include one or more direction signals and/or one or more magnitude signals. The one or more direction signals may be translated into one of the accelerate-forward (or fast-forward), accelerate-backward (or fast-backward), skip-forward, and skip-backward function commands. The one or more magnitude signals (e.g., provided by the one or more capacitive sensors and/or pressure sensors) may be translated into an associated magnitude (e.g., acceleration, speed, and/or amount) command. The media-control command may include the function command and/or the magnitude command. As an example, if the one or more “joystick” signals include a direction/orientation signal associated with portion 226, the one or more “joystick” signals may be translated into the skip-forward command for forwarding the content played by the media playback device according to a set of section/chapter marks associated with the content. The one or more “joystick” signals may also include at least a magnitude signal. According to the magnitude signal, control device 200 (and/or the controlled media playback device) may adjust the acceleration, the speed, and/or the amount for skip-forwarding the content playback.

In step 518, control device 200 (and/or the controlled media playback device) may translate the one or more “motion” signals and/or the one or more “joystick” signals into a media-control command. In one or more embodiments, the direction signals and/or the magnitude signals in the one or more “motion” signals and the one or more “joystick” signals may be combined based on a predetermined algorithm. In one or more embodiments, one of the one or more “motion” signals and the one or more “joystick” signals may be given priority, and the other may be ignored given the presence of the prioritized signal(s).

In step 522, control device 200 (and/or the controlled media playback device) may determine whether one or more “motion” signals or one or more “joystick” signals have been received. If one or more “motion” signals (but no “joystick” signals) have been received, control may be transferred to step 524; if one or more “joystick” signals (but no “motion” signals) have been received, control may be transferred to step 526; if one or more “motion” signals and one or more “joystick” signals have been received, control may be transferred to step 528.

In step 524, control device 200 (and/or the controlled media playback device) may translate the one or more “motion” signals into an ambience-control command. Step 524 may be similar to step 514. However, instead of being translated into a media-control function command, the one or more direction signals may be translated into one of several ambience-control function commands, such as the increase-volume, decrease-volume, increase-lighting, decrease-lighting, increase-temperature, decrease-temperature, open-blinds, and close-blinds function commands. The one or more magnitude signals may be translated into a magnitude (e.g., acceleration, change-rate, and/or amount) command associated with the function command determined based on the one or more direction signals. The ambience-control command may include the function command and/or the magnitude command.

In step 526, control device 200 (and/or the controlled media playback device) may translate the one or more “joystick” signals into an ambience-control command. Step 526 may be similar to step 524. However, instead of being translated into a media-control function command, the one or more direction signals may be translated into one of several ambience-control function commands.

In step 528, control device 200 (and/or the controlled media playback device) may translate the one or more “motion” signals and/or the one or more “joystick” signals into an ambience-control command. Step 528 may be similar to step 518. However, instead of being translated into a media-control command, the combination or the prioritized one of the one or more “motion” signals and/or the one or more “joystick” signals may be translated into an ambience-control command.

The method of the example FIG. 5 may enable the user to perform media control and ambience control utilizing either of “motion” signals and “joystick” signals. If the user's thumbs and/or other fingers are tired, the user may perform the controls utilizing “motion” signals; if the user's arm, elbow, or wrist is tired, or if the user would like to avoid interfering, with other people sitting next to the user, the user may perform the controls utilizing “joystick” signals. Advantageously, flexibility and ergonomics may be optimized. and the fatigue of the user resulted from performing the controls may be reduced or prevented.

FIG. 6 shows a flowchart illustrating a method for controlling content playback and ambience in accordance with one or more embodiments of the present invention. The method may be implemented, for example, utilizing control device 300 illustrated in the example of FIG. 3. The method may start with step 602, in which control device 300 (and/or the playback device controlled by control device 300) by receive one or more “motion” signals from one or more motion-sensing mechanisms in control device 300. The one or more “motion” signals may include one or more direction signals and/or one or more magnitude signals similar to those discussed in step 514 in the example of FIG. 5. In step 602, control device 300 (and/or the controlled playback device) may also determine which one of media-control button 302 and ambience-control button 304 is actuated (e.g., pressed or touched). If media-control button 302 is actuated, control may be transferred to step 614; if ambience-control button 304 is actuated, control may be transferred to step 624.

Step 614 may be similar to step 514 in the example of FIG. 5. In step 614, control device 300 (or the controlled playback device) may translate the one or more “motion” signals into a media-control command, which may instruct the control playback device to perform a media-control action and may define the acceleration, the speed, and/or the amount associated with the media-control action. The media-control action may represent, for example, a fast-forward, fast-backward, skip-forward, or skip-backward action.

Step 624 may be similar to step 524 in the example of FIG. 5. In step 624, control device 300 (or the controlled playback device) may translate the one or more “motion” signals into an ambience-control command, which may instruct the control playback device to perform an ambience-control action and may define the acceleration, the speed (or change rate), and/or the amount associated with the ambience-control action. The ambience-control action may represent, for example, an increase-volume, decrease-volume, increase-lighting, or decrease-lighting action.

The method of the example FIG. 6 may enable the user to perform media control and ambience control utilizing simple, intuitive gestures. The user may not need to look at the buttons in performing the controls. Advantageously, the controls may be easily performed, and the user may not be substantially distracted from the content that the user is watching or listening to.

FIG. 7 shows a flowchart illustrating a method for controlling content playback and ambience in accordance with one or more embodiments of the present invention. The method may be implemented, for example, utilizing control device 400 illustrated in the example of FIG. 4. The method may start with step 702, in which control device 400 (and/or the playback device controlled by control device 400) by receive one or more “joystick” signals from one or more joystick sensor(s), capacitive sensor(s), and/or pressure sensor(s) in control device 400. The one or more “joystick” signals may include one or more direction signals and/or one or more magnitude signals similar to those discussed in step 516 in the example of FIG. 5. In step 702, control device 400 (and/or the controlled playback device) may also determine which one of media-control button 402 and ambience-control button 404 is actuated (e.g., pressed or touched). If media-control button 402 is actuated, control may be transferred to step 716; if ambience-control button 404 is actuated, control may be transferred to step 726.

Step 716 may be similar to step 516 in the example of FIG. 5. In step 716, control device 400 (or the controlled playback device) may translate the one or more “joystick” signals into a media-control command, which may instruct the control playback device to perform a media-control action and may define the acceleration, the speed, and/or the amount associated with the media-control action. The media-control action may represent, for example, a fast-forward, fast-backward, skip-forward, or skip-backward action.

Step 726 may be similar to step 526 in the example of FIG. 5. In step 726, control device 400 (or the controlled playback device) may translate the one or more “joystick” signals into an ambience-control command, which may instruct the control playback device to perform an ambience-control action and may define the acceleration, the speed (or change rate), and/or the amount associated with the ambience-control action. The ambience-control action may represent, for example, an increase-volume, decrease-volume, increase-lighting, or decrease-lighting action.

The method of the example FIG. 7 may enable the user to perform media control and ambience control utilizing only thumb movement without substantially moving the user's wrist, elbow, or arm. Since there are only one button for each of media control and ambience control, the user may not need to look at the buttons in performing the controls. Advantageously, the controls may be easily performed, and the user may not be substantially distracted from the content that the user is watching or listening to.

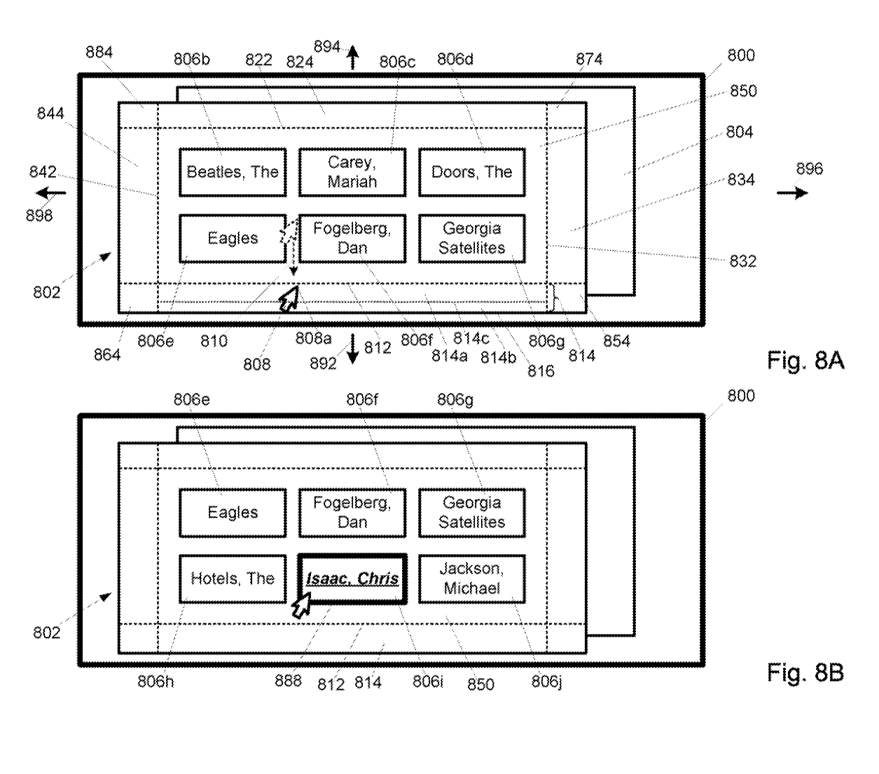

FIG. 8A shows a schematic representation illustrating a displayed portion of a menu and illustrating scroll zones for controlling the display of the information contained in the menu in accordance with one or more embodiments of the present invention. The display of the menu may be controlled, for example, utilizing control device 200, 300, or 400 illustrated in the example of FIG. 2, 3, or 4. As an example, control device 200 may include a “menu” button 252 for activating one or more on-screen menus to be displayed on one or more display areas (or windows), such as display areas 802 and 804, on a display device 800, e.g., a television or a liquid crystal display. For example, display area 802 may show a portion of a menu, hereinafter referred the first portion of the menu; the first portion of the menu may include several menu items, such as menu items 806b, 806c, 806d, 806e, 806f, and 806g. For example, the menu items may represent artist names, movie titles, and/or cover arts for audio/video content items. The menu, items may be show in a menu-item zone 850 (or actionable zone 850) of display area 802 for receiving user selection and/or actuation, in one or more embodiments, a menu-item zone may be equivalent to a display area.

“Menu” button 252 may also enable a user of control device 200 to navigate the one or more menus for choosing options or providing commands. For example, “menu” button 252 may represent a multi-way button (or joystick), for example, implemented utilizing one or more joystick sensors, capacitive sensors, and/or pressure sensors, for controlling the movement of an indicator, such as an on-screen pointer 808 or a menu-item highlighting effect (e.g., a font/format change 888 of a menu item 806i shown in the example of FIG. 8B), to perform the navigation. Alternatively or additionally, control device 200 may include one or more motion-sensing mechanisms, such as one or more accelerometers and/or gyroscopes, for facilitating the user of control device 200 to move the indicator by utilizing various gestures that cause various motions of control device 200.

Display area 802 may also include one or more scroll zones, such as scroll zones 814, 824, 834, 844, 854, 864, 874, and 884, for cooperating with the indicator to facilitating scrolling display area 802 with respect to the menu. For example, if a portion of the indicator (e.g., pointer tip 808a of pointer 808 or any portion of a highlighted menu item) is disposed in scroll zone 834, display device 800 and/or the menu-presenting device (e.g., a media playback device) controlled by control device 200 may scroll display area 802 with respect to the menu in a direction 896 to show a second portion of the menu. From the user's point of view, display area 802 may stay still on display device 800 while the menu may move in direction 898 opposite to direction 896. As another example, if pointer tip 808a is in scroll zone 854, display area 802 may be scrolled with respect to the menu in both direction 896 and direction 892 to show a third portion of the menu. As another example, if pointer tip 808a of pointer 808 is in scroll zone 814, display area 802 may be scrolled with respect to the menu in a direction 892 (i.e., the menu may be scrolled in direction 894 with respect to display area 802) to show a fourth portion of the menu illustrated in the example of FIG. 8B.

FIG. 8B shows a schematic representation illustrating the fourth portion of the menu after display area 802 has been scrolled with respect to the menu in direction 892 in accordance with one or more embodiments of the present invention. As an example, the fourth portion of the menu may include menu items 806e, 806f, 806g, 806h, 806i, and 806j. In the example, after the scrolling, a section of the first portion of the menu including menu items 806b, 806c, and 806d is concealed; and menu items 806e, 806f, and 806g are still shown. As a result of other scrolling actions, menu items 806e, 806f, and 806g may also be concealed for accommodating and showing other menu items in display area. 802. The amount, speed, and/or acceleration of a scroll action may depend on the duration that the portion of the indicator (e.g., pointer tip 808a) stays in scroll zone 814 and/or the position of the portion of the indicator in scroll zone 814.

For example, referring back to the example of FIG. 8A, scroll zone 814 may be divided into at least a sub-zone 814a and a sub-zone 814b defined by a boundary 814c. If pointer tip 808a is in sub-zone 814a, display area 802 may be scrolled with respect to the menu (i.e., the fourth portion of the menu may be revealed) at a first speed and/or a first acceleration level. If pointer tip 808a is in sub-zone 814b, display area 802 may be scrolled with respect to the menu at a second speed and/or a second acceleration level that may be higher than the first speed and/or the first acceleration level. Boundary 814c between sub-zone 814a and sub-zone 814b may be configured invisible to the user for simplifying display area 802 and minimizing distraction to the user. In one or more embodiments, boundary 814c may be configured visible to the user for enabling the user to perform more precise control. In one or more embodiments, user input may be received for configuring whether to visibly show boundary 814c. In one or more embodiments, scroll zone 814 may include more than two sub-zones that are associated with more than two speeds and/or more than, two acceleration levels for scrolling tire menu.

The boundaries between the scroll zones and menu-item zone 850, e.g., boundaries 812, 822, 832, aid 842, as well as the scroll, zones, may not be visibly shown or indicated on the display device. Therefore, the user may not need to look for the scroll zones as the user would need to look for a direction button or scrollbar in a prior art arrangement. The directions for scrolling display area 802 with respect to the menu may be consistent with the directions in which the user moves the indicator away from the displayed portion of the menu (i.e., towards edges or corners of display 802). For example, the user may intuitively move down pointer 808 in direction 810 (towards edge 816) to show menu items 806h-806j below menu items 806e-806g. Advantageously, the user may easily and intuitive move pointer tip 808a into a suitable scroll zone to scroll display area 802 with respect to the menu. The user may not need to accurately locate a direction button or scrollbar, and the user may not need to press or hold any button of control device 200.

In one or more embodiments, one or more of the boundaries between the scroll zones and menu-item zone 850 may be configured visible to the user for enabling the user to perform more precise control. In one or more embodiments, user input may be received for configuring whether to visibly show one or more of the boundaries.

In one or more embodiments, a menu-item zone may overlap one or more scroll zones. In one or more embodiments, scroll zones may be defined as outside a display area, and an indicator may be at least partially invisible to the user if the indicator is in a scroll zone. Accordingly, the dimensions of a menu-item zone may be maximized, and more menu items may be shown in the display area.

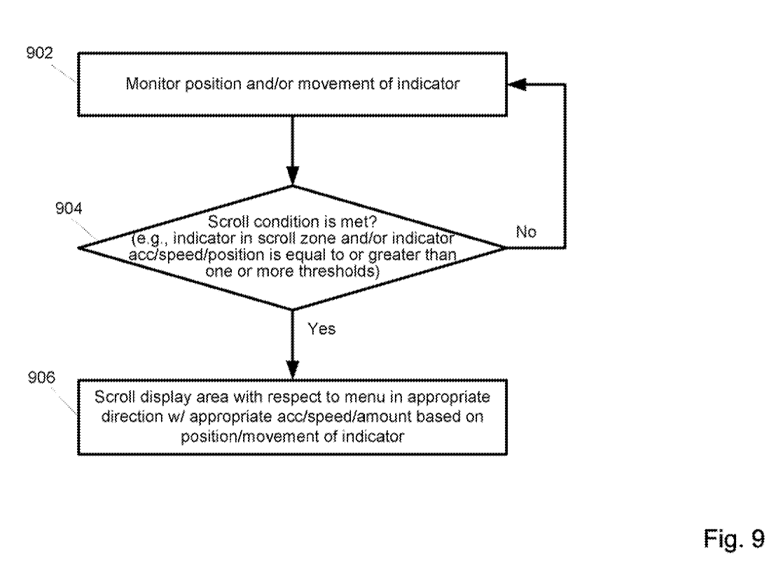

FIG. 9 shows a flowchart illustrating a method for controlling the display of the information contained in the menu in accordance with one or more embodiments of the present invention. The method may be implemented, for example, utilizing control device 200, 300, or 400 illustrated in the example of FIG. 2, 3, or 4 and/or utilizing display device 800 illustrated in the examples of FIGS. 8A-8B. The method may start with step 902, in which, for example, control device 200, display device 800, and/or the menu-presenting device (e.g., a media playback device) controlled by control device 200 may monitor the position and/or the movement of the indicator. As an example, the indicator may be pointer 808 and/or a menu-item highlighting effect, e.g., as illustrated by font/format change 888.

In step 904, control device 200, display device 800, and/or the menu-presenting device may determine whether a scroll condition is met. If the scroll condition is not met, control may be transferred back to step 902, in which control device 200, display device 800, and/or the menu-presenting device may continue to monitor the position and/or the movement of the indicator. If the scroll condition is met, control may be transferred to step 906, in winch device 800 and/or the menu-presenting device may scroll display area 802 with respect to the menu in an appropriate direction (i.e., scroll the menu with respect to display area in the opposite direction) with appropriate acceleration, speed, and/or amount based on the position and/or the movement of the indicator. The acceleration, the speed, and/or the amount of the scrolling may be a function of the acceleration, the speed, and/or the position of the indicator. The acceleration, the speed, and/or the position of the indicator may depend on the motion of control device 200 or the movement of “menu” button 252.

In one or more embodiments, the scroll condition may include the condition that a portion of the indicator is in a scroll zone, as previously discussed with reference to the examples of FIGS. 8A-8B.

In one or more embodiments, the scroll condition may include the condition that the acceleration, the speed, and/or the position of the indicator and/or control device 200 is equal to or greater than one or more thresholds. As an example, a threshold for the speed of the indicator may be set to be zero in the scroll condition. Accordingly, as long as the indicator and/or control device 200 moves, display device 800 and/or the menu-presenting device may scroll display area 802 with respect to the menu in the direction of the movement of the indicator. For example, if pointer 808 and/or control device 200 moves in direction 898, then display area 802 may be scrolled with respect to the menu in direction 898, causing menu items 806d and 806g to be concealed, and causing previously hidden menu items to the left of menu items 806b and 806e to be revealed.

As another example, the threshold for the speed of the indicator may be set to be a value that is greater than zero. Accordingly, display area 802 may not be scrolled until the speed of the indicator and/or control device 200 reaches the value. In one or more embodiments, the indicator is not shown on display device 800, and the scrolling of display area 802 is controlled based on the movement of control device 200.

In one or more embodiments, if the acceleration level of the movement of the indicator is greater than or equal to a predetermined threshold, display device 800 and/or the menu-presenting device may perform a page-skipping or section-skipping action, scrolling display area 802 with respect to the menu to show the next page or next section of the menu. For example, the user of control device 200 may trigger one or more page/section-skipping actions in a certain direction by swiftly swinging control device 200 one or more times in the direction. No button of control device 200 may need to be pressed. As a result of a page/section-skipping action, the newly display portion of the menu may be adjacent to the previously displayed portion of the menu and may not overlap the previously displayed portion of the menu, and the previously displayed portion of the menu may be completely concealed.

In one or more embodiments, a page/section-skipping action in an appropriate direction may be triggered if a portion or the pre-selected portion of the indicator is in a scroll zone associated with tire direction, in one or more embodiments, a page/section-skipping action in an appropriate direction may be triggered if a portion or the pre-selected portion of the indicator is in a designated sub-zone (e.g., sub-zone 814b, but not sub-zone 814a) associated with the direction. No button of control device 200 may need to be pressed.

In one or more embodiments, without the presence of an indicator shown on display device 800, if the acceleration level of the movement of control device 200 is greater than or equal to a predetermined threshold, display device 800 and/or the menu-presenting device may perform a page-skipping or section-skipping action, scrolling display area 802 with respect to the menu to show the next page or next section of the menu.

As can be appreciated from the foregoing, embodiments of the invention may effectively reduce the number of buttons required for control devices. Accordingly, embodiments of the invention may reduce complexity and inconvenience in controlling media/content playback and ambience. Embodiments of the invention may also optimize flexibility and ergonomics for users in performing media control and ambience control. Advantageously, ease of use and satisfactory user experience may be provided.

Embodiments of the invention may also reduce the form factors of control devices. Advantageously, portability of the control devices may be improved, and the storage and shipping costs for the control devices may be reduced.

Embodiments of the invention may also enable intuitive and simple operation for scrolling on-screen menus (or display areas). Embodiments of the invention may eliminate the need for finding a direction button or scrollbar. Embodiments of the invention may also eliminate the need for pressing and holding a button of a control device. Advantageously, inconvenience and/or fatigue associated with operating on-screen menus may be minimized.

While this invention has been described in terms of several embodiments, there are alterations, permutations, and equivalents, which fall within the scope of this invention. It should also be noted that there are many alternative ways of implementing the methods and apparatuses of the present invention. Furthermore, embodiments of the present invention may find utility in other applications. The abstract section is provided herein for convenience and, due to word count limitation, is accordingly written for reading convenience and should not be employed to limit the scope of the claims. It is therefore intended that the following appended claims be interpreted as including all such alterations, permutations, and equivalents as fall within the true spirit and scope of the present invention.

What is claimed is:

1. A method for controlling displaying information contained in a menu on a display device, items in the menu configured to be selected using a control device, a first, portion of the menu initially shown in a display area on the display device, the method comprising:
monitoring a position of an indicator, the indicator controlled by the control device;
concealing at least a first section of the first portion of the menu if a portion of the indicator is in a first zone on the display device and if no button of the control device is currently pressed; and
showing a second portion of the menu if the portion of the indicator is in the first zone on the display device and if no button of the control device is currently pressed.

2. The method of claim 1 wherein at least one boundary of the first zone is not visibly shown on the display device.

3. The method of claim 1 further comprising:
concealing at least a second section of the first portion of the menu if the portion of the indicator is in a second zone on the display device and if no button of the control device is currently pressed; and
showing a third portion of the menu if the portion of the indicator is in the second zone on the display device and if no button of the control device is currently pressed.

4. The method of claim 1 further comprising:
scrolling the display area with respect to the menu in a first direction if the portion of the indicator is in the first zone on the display device and if no button of the control device is currently pressed;
scrolling the display area with respect to the menu in a second direction if the portion of the indicator is in a second zone on the display device and if no button of the control device is currently pressed; and
scrolling the display area with respect to the menu in the first direction and in the second direction if the portion of the indicator is in a third zone on the display device and if no button of the control device is currently pressed.

5. The method of claim 4 further comprising:
scrolling the display area with respect to the menu in a third direction if the portion of the indicator is in a fourth zone on the display device and if no button of the control device is currently pressed; and
scrolling the display area with respect to the menu in the first direction and in the third direction if the portion of the indicator is in a fifth zone on the display device and if no button of the control device is currently pressed.

6. The method of claim 1 further comprising:
adjusting at least one of an acceleration level and a speed according to the position of the indicator in the first zone; and
revealing the second portion of the menu at the at least one of the acceleration level and the speed.

7. The method of claim 1 further comprising:
dividing the first zone into at least a first sub-zone and a second sub-zone;
revealing the second portion of the menu at one or more of a first speed and a first acceleration level if the portion of the indicator is in the first sub-zone; and
revealing the second portion of the menu at one or more of a second speed and a second acceleration level if the portion of the indicator is in the second sub-zone.

8. The method of claim 7 wherein a boundary between the first sub-zone and the second sub-zone is not shown on the display device.

9. The method of claim 1 further comprising:
dividing the first zone into at least a first sub-zone and a second sub-zone;
showing at least a second section of the first portion of the menu if the portion of the indicator is in the first sub-zone; and
completely concealing the first portion of the menu if the portion of the indicator is in the second sub-zone.

10. The method of claim 1 further comprising:
determining the first section of the first portion of the menu according to the position of portion of the indicator in the first zone; and
determining the second portion of the menu according to the position of the portion of the indicator in the first zone.

11. The method of claim 1 wherein the first portion of the menu represents a first page of the menu, and the second portion of the menu represents a second page of the menu.

12. The method of claim 1 wherein the portion of the indicator is a pre-selected portion of the indicator.

13. The method of claim 1 wherein the indicator includes at least one of a menu-item font effect, a menu-item format change, and a menu-item highlighting effect.

14. A method for controlling displaying information contained in a menu on a display device, a first portion of the menu initially shown in a display area on the display device, the method comprising:
monitoring movement of at least one of an indicator and a control device when no button of the control device is currently pressed, the movement of the indicator affected by the control device;
determining a direction of the movement of the at least one of the indicator and the control device; and
scrolling the display area with respect to the menu in the direction of the movement of the at least one of the indicator and the control device to show a second portion of the menu on the display device.

15. The method of claim 14 further comprising:
determining at least one of an acceleration level and a speed of the movement of the indicator;
determining at least one of a second acceleration level and a second speed based on the at least one of the acceleration level and the speed of the movement of the indicator; and
performing the scrolling at one or more of the second acceleration level and the second speed.

16. The method of claim 14 further comprising:
determining an acceleration level of the movement; and
if the acceleration level of the movement of the indicator is greater than or equal to a predetermined acceleration threshold, selecting the second portion of the menu such that the second portion of the menu is adjacent to the first portion of the menu and does not overlap the first portion of the menu.

17. The method of claim 14 further comprising:
determining whether a portion of the indicator is in a first zone on the display device; and
if the portion of the indicator is in the first zone on the display device, selecting the second portion of the menu such that the second portion of the menu is adjacent to the first portion of the menu and does not overlap the first portion of the menu.

18. The method of claim 14 wherein the at least one of the indicator and the control device represents the control device, and the indicator is not shown on the display device.

19. A method for controlling displaying information contained in a menu on a display device, a first portion of the menu initially shown in a display area on the display device, the method comprising:
monitoring movement of at least one of an indicator and a control device when no button of the control device is currently pressed, the movement of the indicator affected by the control device;
determining a direction of the movement of the at least one of the indicator and the control device;
determining a speed of the at least one of the indicator and the control device; and
if the speed of the at least one of the indicator and the control device is greater than or equal to a predetermined speed threshold, scrolling the display area with respect to the menu in the direction of the movement of the at least one of the indicator and the control device to show a second portion of the menu on the display device.

20. The method of claim 19 further comprising:
determining an acceleration level of the movement; and
if the acceleration level of the movement of the indicator is greater than or equal to a predetermined acceleration threshold, selecting the second portion of the menu such that the second portion of the menu is adjacent to the first portion of the menu and does not overlap the first portion of the menu, and completely concealing the first portion of the menu.

21. The method of claim 19 further comprising:
determining whether a portion of the indicator is in a first zone on the display device; and
if the portion of the indicator is in the first zone on the display device, selecting the second portion of the menu such that the second portion of the menu is adjacent to the first portion of the menu and does not overlap the first portion of the menu, and completely concealing the first portion of the menu.
